(19) United States
(12) Patent Application Publication
(10) Pub. No.: US 2017/0345049 A1
(43) Pub. Date: Nov. 30, 2017

(54) SYSTEM AND METHOD FOR PROVIDING AD CAMPAIGNS TO COMPUTING DEVICES

(71) Applicant: Wal-Mart Stores, Inc., Bentonville, AR (US)

(72) Inventors: Somnath Banerjee, Foster City, CA (US); Alex H. Frey, Millbrae, CA (US); Abhimanyu Mitra, San Jose, CA (US)

(21) Appl. No.: 15/167,195

(22) Filed: May 27, 2016

(51) Int. Cl. G06Q 30/02

(52) U.S. Cl. CPC G06Q 30/0246; G06Q 30/0255

(57) ABSTRACT

A method and a web server store a plurality of web page elements that may be rendered on a browser of a user computing device to display a web page. The web page includes a first ad space for displaying an ad that is visible to the user and a second ad space for displaying an ad that is not visible to the user. A first ad request for the first ad space and a second ad request for the second ad space are received and associated with a first ad campaign and a second ad campaign, respectively. A first ad from the first ad campaign is provided to the user computing device so that the first ad is visible to the user, and a second ad from the second ad campaign is provided to the user computing device so that the second ad is not visible to the user.

### FIELD OF THE DISCLOSURE

The present disclosure relates generally computerized advertising platforms, and more specifically, to a system and method for providing ad campaigns to computing devices.

### BACKGROUND

Online advertising campaigns are often used to advertise a particular company, service, and/or product through a coordinated series of advertisements or promotional marketing messages delivered to a targeted audience by way of an online or Internet-based marketing channel. Online advertising campaigns are typically used to boost awareness of the particular company, service, and/or product for purposes of generating a demand for the product, the service, and/or products and services of the company.

There are various ways of assessing the effectiveness of an advertising campaign. One way of assessing the effectiveness of an online advertising campaign is by calculating a click-through rate (CTR). The click-through rate generally represents the number of clicks on an icon or hyperlink of an online advertisement per the number of times the advertisement was shown. Typically, a click-through rate of 0.2% or higher is indicative of an effective online advertising campaign. Although useful, the click-through rate does not take into account activity which occurs offline, such as data pertaining to transactions and/or consumer behavior that take place in an offline store. A targeted audience for an online advertising campaign which is developed solely utilizing the click-through rate is therefore limited to consumers and consumer activity that occurs online.

In addition, the click-through rate may not determine the effectiveness of the actual ad campaign in driving sales of a product. The click-through rate essentially measures clicks or engagement of the user with the campaign. However, advertisers often want to drive sales of their products through the ad campaign. The click-through rate is unable to measure the true sales impact of the Ad campaign. Therefore often advertisers measure a conversion rate, which is the fraction of people who made the purchase of the promoted products after seeing the ad. The conversion rate, however, is not a true measure of the effectiveness since an ad campaign can see a high conversion rate if it is just targeting the right set of people to show the ad. For example, a diaper campaign will observe a high conversion rate if it shows ads to the parents with a newborn baby at home. In the above example, those parents may buy diapers even if they do not see the ad. The true effectiveness of an ad campaign is more accurately determined by measuring the incremental impact of the campaign. The incremental impact reflects the additional sales of products from customers who see the ad as compared to customers who do not see the ad.

A traditional way of assessing the effectiveness of an advertising campaign is through what is known as A/B testing. With A/B testing, an ad server is configured to randomly divide the ad requests for a given campaign into two groups (sometimes referred to as treatment and control groups, or A and B groups). A user requesting the ad will exclusively fall either in the treatment or in the control group. The treatment group is served with the ad from the ad campaign. The control group is either served nothing or served something that is not related to the ad campaign. In this setup, treatment and control groups are randomly partitioned at the time of serving ads, and the only difference between the treatment and control group is the ad exposure. Once the control group is determined, the incremental sales may be measured by computing the difference in sales between the treatment and control group.

The above approach, albeit simple, is actually very expensive. The control group is either served no ads or served unrelated ads creating an opportunity loss. In case of no ads, the ad inventory of the publisher gets wasted, typically the advertiser needs to bear the opportunity cost paying for the ad impressions that were not served. A similar situation is present when the control group is served unrelated ads. If an ad is unrelated to the campaign then it is a waste for the advertiser to pay for the impression. Apart from the cost, it is much more complicated for the ad server to deliver ads of an unrelated campaign as part of another campaign under experiment. To do this, the ad server needs to implement the often complicated logic of logging the ad impressions and billing the advertisers. Therefore obtaining the control group is costly for the advertisers. A sizable control group is also needed to be able to perform a statistically significant measurement of the incremental sales. This often means that the advertiser needs to spend a sizable amount of money on delivering unrelated ads or in foregoing revenue resulting from not delivering ads.

The present disclosure is aimed at solving one or more of the problems identified above.

### BRIEF SUMMARY

In one embodiment, a system includes a memory device configured to store a plurality of web page elements that may be rendered on a browser of a user computing device to display a web page. The web page includes a first ad space for displaying an ad that is configured to be visible to the user and a second ad space for displaying an ad that is configured to not be visible to the user. The system also includes a web server coupled to the memory device. The web server is configured to receive a request from the user computing device to display the web page, and provide the web page elements to the user computing device to enable the browser of the user computing device to display the web page. The system also includes an ad server configured to receive a first ad request for the first ad space from the user computing device, and receive a second ad request for the second ad space from the user computing device. The first ad request and the second ad request include an identifier associated with the user computing device. The first ad request is associated with a first ad campaign based on the identifier, and the second ad request is associated with a second ad campaign based on the identifier. A first ad from the first ad campaign is provided to the user computing device in response to the first ad request to enable the first ad to be visible to the user. A second ad from the second ad campaign is provided to the user computing device in response to the second ad request to enable the second ad to not be visible to the user.

In another embodiment, a method includes storing a plurality of web page elements within a memory device of a web server to enable a browser of a user computing device to render a web page. The web page includes a first ad space for displaying an ad that is configured to be visible to the user and a second ad space for displaying an ad that is configured to not be visible to the user. A request is received from the user computing device to display the web page, and the web page elements are provided to the user computing device to enable the browser of the user computing device to display the web page. A first ad request for the first ad space is received from the user computing device, and a second ad request for the second ad space is received from the user computing device. The first ad request and the second ad request include an identifier associated with the user computing device. The first ad request is associated with a first ad campaign based on the identifier, and the second ad request is associated with a second ad campaign based on the identifier. A first ad from the first ad campaign is provided to the user computing device in response to the first ad request to enable the first ad to be visible to the user. A second ad from the second ad campaign is provided to the user computing device in response to the second ad request to enable the second ad to not be visible to the user.

### BRIEF DESCRIPTION OF THE DRAWINGS

Advantages of the present disclosure will be readily appreciated, as the same becomes better understood by reference to the following detailed description, when considered in connection with the accompanying drawings. Non-limiting and non-exhaustive embodiments of the present disclosure are described with reference to the following figures, wherein like numerals refer to like parts throughout the various views unless otherwise specified.

FIG. 1 is a block diagram illustrating an exemplary system that may be used to present one or more advertisements to a.

FIG. 2 is a block diagram of an exemplary web page that may be presented to a user on a user computing device using the system shown in FIG. 1.

FIG. 3 is a block diagram of a computing device that may be used with the system shown in FIG. 1.

FIG. 4 is a flow diagram of an exemplary method of associating user computing devices with one or more ad campaigns that may be used with the system shown in FIG. 1.

FIG. 5 is a flow diagram of an exemplary method of determining an effectiveness of one or more ad campaigns that may be used with the system shown in FIG. 1.

### DETAILED DESCRIPTION

The present disclosure particularly describes a system that provides ads from a plurality of ad campaigns to users who visit a web page. The system then determines an effectiveness of each ad campaign.

In a specific embodiment, the system includes a web server, an ad server, and a user computing device. The ad server provides a plurality of ad campaigns that are designed to influence users to purchase a product. As part of each ad campaign, a main ad is provided that is designed to be visible to the users, and an invisible ad is provided that is designed to be not visible to the users. The users who are presented with the main ad are assigned to a test group and the users who are presented with the invisible ad instead of the main ad are assigned to a control group.

When a user operates a user computing device to browse a web page, the web server provides the web page elements to the user computing device to enable the user computing device to render the web page. In one embodiment, the web page includes spaces for a main ad and an invisible ad. The user computing device calculates a bucket identifier based on a device identifier of the user computing device. The user computing device transmits a first request for the main ad and a second request for the invisible ad to the ad server. In the first and second requests, the user computing device includes the bucket identifier and a page identifier that identifies the web page the user was browsing. The ad server then determines which ad campaign the user and/or user computing device is associated with for the first request associated with the main ad, and which ad campaign the user and/or user computing device is associated with for the second request associated with the invisible ad. The ad server then provides the main ad from the ad campaign associated with the first request and an invisible ad from the ad campaign associated with the second request to the user computing device. The web server may track the ads shown to the user and may also track the purchases made by the user while browsing the web page as part of a purchase history of the user. The purchase history of the user (and of other users who were served the main ad and the invisible ad) may then be used to determine the effectiveness of the ad campaign associated with the main ad and the ad campaign associated with the invisible ad.

The embodiments described herein present a cost-effective ad campaign framework that can be implemented by any suitable publisher operating the web server. The changes required to implement the framework on an ad server are not intrusive which means that a publisher may use the framework with existing ad servers rather than switching to a different ad server. In addition, the embodiments described herein may be used to measure the effectiveness of multiple ad campaigns running at the same time on a particular web page or site.

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment of example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system”. Furthermore, the present invention may take the form of a computer program product embodied in any tangible media or expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisional via virtualization and released with minimal management effort or service provider interaction, and then scaled accordingly. A cloud model can be composed of various characteristics on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagram(s) in the flow diagram(s) illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware-based systems that perform the specified functions or acts, or combinations of special purpose hardware and computer instructions. These computer program instructions may also be stored in a computer-readable media that can direct a computer, processor, or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with” or “configured to be in communication with”. This terminology is intended to be non-limiting, and where appropriate, be interpreted to include without limitation, wired and wireless communication using any one or a plurality of suitable protocols, as well as communication methods that are constantly maintained, are made on a periodic basis, and/or made or initiated on an as needed basis.

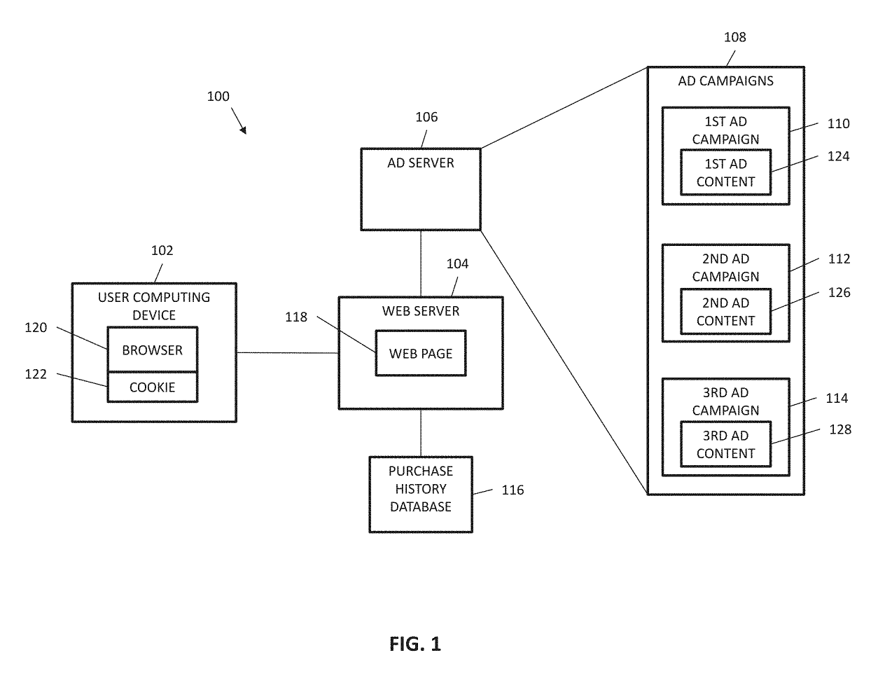

FIG. 1 is a block diagram of an exemplary system 100 that may be used to present one or more advertisements (“ads”) from one or more ad campaigns to a user and to measure the effectiveness of each ad campaign. While the embodiments described herein refer to ads and ad campaigns, it should be recognized that the embodiments may include any suitable text, image, and/or video content in addition to or instead of ads.

In one embodiment, system 100 includes a user computing device 102, a web server 104, an ad server 106, and a plurality of ad campaigns 108 including a first ad campaign 110, a second ad campaign 112, and a third ad campaign 114. System may also include a purchase history database 116 coupled to web server 104. The various components of system 100 may be connected together by one or more wired or wireless networks. Although three ad campaigns 108 are illustrated in FIG. 1, any suitable number of ad campaigns may be used. Also, while system 100 is illustrated with the above components, it should be recognized that one or more components of system 100 may be combined together or split apart while remaining in the scope of the disclosure.

User computing device 102 is a computing device that may be operated by a user to present one or more web pages 118 to the user. The user computing device 102 may include, for example, a mobile phone, a personal digital assistant, a laptop computer, a desktop computer, a tablet computer, a wearable computing device, or another suitable device that enables the user to browse web pages and purchase products. User computing device 102 includes software in the form of a web browser 120 (or “browser”) that enables web pages to be viewable on user computing device 102. During a browsing session, one or more cookies 122 or similar files may be temporarily or persistently stored within memory of the user computing device 102. In one embodiment, the cookie 122 stores information relating to the user's browsing session, including an identifier for the user computing device 102 (referred to herein as a “device identifier”). The device identifier may be a random value assigned to the user computing device 102, a MAC address of the network interface of user computing device 102, a value obtained from one or more serial numbers or other identifiers of one or more components of user computing device 102 (such as a value obtained by performing a hash algorithm on the serial numbers or similar identifiers of one or more components of user computing device 102), or any other suitable identifier.

Web server 104 is a computing device operated by a retailer or another suitable entity that enables multiple user computing devices 102 to access one or more web pages 118 for one or more websites. In one embodiment, web pages 118 enable a user to browse a product listing or catalog of the retailer and purchase one or more products. Web pages 118 may also include a plurality of ads displayed within a plurality of ad spaces defined within the web page 118 as described more fully herein. The web pages 118 may be stored within a memory of web server 104 as a plurality of web page elements that are transmitted to a user computing device 102 to enable the browser 120 to render the elements as a web page 118 that is then displayed on a display of the user computing device 102. Each web page 118 may be associated with a web page identifier that may be used to facilitate targeting ads to users as described more fully herein.

Ad server 106 is a computing device that provides ads or other content to user computing device 102 in response to the user browsing the web page 118 with browser 120. When one or more ad campaigns are underway, ad server 106 may select which ad campaign to receive ads from in response to the user browsing the web page 118 as is described more fully herein.

Each ad campaign 108 may represent an advertisement strategy of an advertiser to influence shoppers to buy a particular product or products. For example, the advertiser may specify what types of users the advertiser wants to target with ads, the specific ads the advertiser wants to present to the users, the timeframe for the campaign, one or more products associated with the campaign, and the like. Each ad campaign may therefore include separate ad content that is identified for presentation to users meeting certain ad campaign conditions or criteria. For example, first ad campaign 110 may include first ad content 124 that will be presented to users meeting the first ad campaign criteria, second ad campaign 112 may include second ad content 126 that will be presented to users meeting the second ad campaign criteria, and third ad campaign 114 may include third ad content 128 that will be presented to users meeting the third ad campaign criteria. The ad content for each campaign may include one or more ads.

Purchase history database 116 stores the purchase history of a plurality of users. In one embodiment, purchase history database 116 stores the purchase history for each user that purchases a product from a retailer through one or more web pages 118 and through one or more retail stores (sometimes referred to as “brick and mortar stores”). The purchase history for a user may include a unique user identifier, product identifiers for the purchased products, the date each product was purchased, the price paid for each product, the location at which the user purchased the products (e.g., the web page 118 or retail store at which the user purchased the product), and the like. In one embodiment, the purchase history of each user is keyed to the unique user identifier, and one or more unique device identifiers retrieved from cookies 122 associated with the user during historical browsing sessions are associated with the unique user identifier.

During operation, a user operates the user computing device 102 to access the web page 118 over a network. The user computing device 102 transmits a request to the web server 104 for the web page elements to display the web page 118. The web server 104 receives the request and transmits the web page elements to the browser 120 of the user computing device 102 to enable the browser 120 to render and display the web page content. If the web page 118 includes one or more spaces for ads, the user computing devices browser 120 requests the ad server 106 to provide ads to be displayed in the spaces. Ad server 106 receives the request and identifies which ad campaign the user and/or user computing device 102 should be associated with. Ad server 106 then provides the ads from the identified ad campaign to the browser 120 of the user computing device 102 in response to the request.

Web server 104 may track which ad campaign the user and/or user computing device 102 was associated with and which ads were shown to the user on the user computing device 102. If the user purchases a product, web server 104 stores the purchase details within purchase history database 116 and the purchase history is associated with the ads shown to the user. When determining an effectiveness of the ad campaign, web server 104 may retrieve the purchase history data from purchase history database 116 for each user that was associated with the ad campaign. Web server 104 then compares the number of users that were shown a main ad of the ad campaign and that purchased a product associated with the campaign to the number of users that were not shown the main ad of the ad campaign but that still purchased the product associated with the campaign. As described more fully herein, the web server 104 then uses the results of the comparison to determine the effectiveness of each ad campaign.

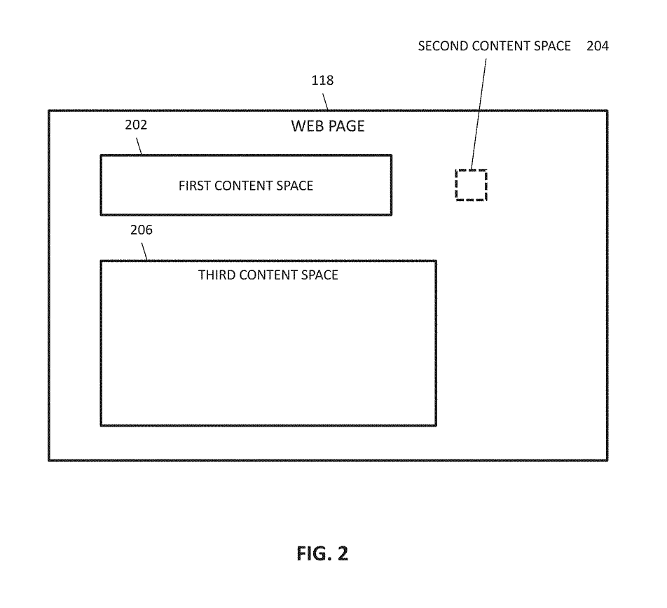

FIG. 2 is a block diagram of an exemplary web page 118 that may be presented to a user on a user computing device 102. In one embodiment, web page 118 includes a plurality of spaces defined to display ads. More specifically, web page 118 may include a first or main content space 202 that may be used to display a first or main ad, and a second or invisible content space 204 that may be used to display a second or invisible ad. A third content space 206 may be used to display other content on the web page 118, such as products that may be purchased by the user, navigational buttons or links, etc. While web page 118 illustrates a first content space 202 and a second content space 204 for displaying first and second ads, it should be recognized that any suitable number of ads and content spaces may be provided in web page 118. In a specific embodiment, each main content space 202 includes an associated invisible content space 204.

Main content space 202 may be sized and placed on web page 118 to be visible to the user so that the main ad displayed therein is also visible to the user. In such a manner, the main ad displayed in main content space 202 is afforded the opportunity to influence the user to buy the product associated with the main ad.

Invisible content space 204 may be sized and placed on web page 118 so that it does not affect the visible layout or placement of the remaining web page content. In one embodiment, invisible content space 204 is a 1 square pixel space (i.e., 1 pixel by 1 pixel) that may be placed on web page 118 to not displace the remaining web page content. In this embodiment, the 1 square pixel size of the invisible content space 204 renders the ad displayed therein not visible to the user due to its small size in comparison to the remaining content on the web page 118. In a specific embodiment, the invisible content space 204 may be appended to the main content space 202 to extend from the main content space 202 by 1 pixel in a horizontal or vertical direction. In another embodiment, invisible content space 204 may have a transparent attribute or property associated therewith such that the ad displayed in the invisible content space 204 is displayed in a transparent manner that is not visible to the user.

The main content space 202 and the invisible content space 204 are designed to support the testing of the effectiveness of multiple ad campaigns simultaneously. For example, a first user who views web page 118 may be presented with an ad for first ad campaign 110 in main content space 202 and may be presented with an ad for second ad campaign 112 in invisible content space 204. A second user who views web page 118 may be presented with an ad for second ad campaign 112 in main content space 202 and may be presented with an ad for third ad campaign 114 in invisible content space 204. A third user who views web page 118 may be presented with an ad for third ad campaign 114 in main content space 202 and may be presented with an ad for first ad campaign 110 in invisible content space 204. Accordingly, the effectiveness of each ad campaign may be assessed using the same web page 118 and content spaces. Thus, the effectiveness of ad campaigns may be determined in a more efficient manner while the retailer who operates web page 118 still receives a full amount of ad revenue from the advertisers (as compared to traditional A/B testing or other known campaign evaluation techniques).

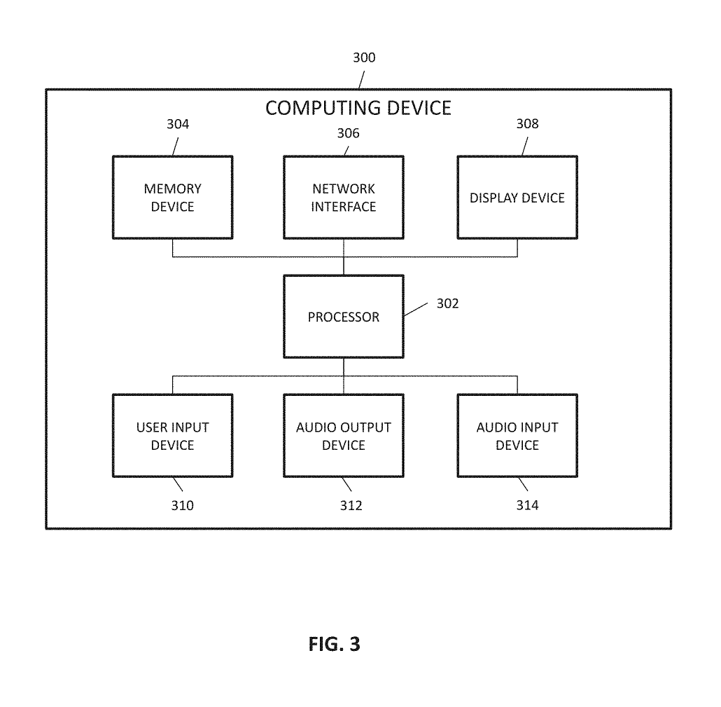

FIG. 3 is a block diagram of a computing device 300 that may be used with system 100 (shown in FIG. 1). More specifically, the user computing device 102, web server 104, and/or ad server 106 described in system 100 may be implemented as a computing device 300. However, it should be recognized that one or more components of computing device 300 may be not be included in user computing device 102, web server 104, and/or ad server 106.

Computing device 300 includes a processor 302, a computer-readable memory device 304, and a network interface 306. In one embodiment, computing device 300 may also include a display device 308, a user input device 310, an audio output device 312, and/or an audio input device 314. It should be recognized that memory device 304, network interface 306, display device 308, and user input device 310 (if provided) may be connected to processor 302 and/or to each other via any suitable bus or busses, interfaces, or other mechanisms.

Processor 302 includes any suitable programmable circuit including one or more microcontrollers, microprocessors, application specific integrated circuits (ASICs), systems on a chip (SoCs), programmable logic circuits (PLCs), field programmable gate arrays (FPGAs), and/or any other circuit capable of executing the functions described herein. The above examples are exemplary only, and thus are not intended to limit in any way the definition and/or meaning of the term “processor.”

Memory device 304 is an electronic storage device that includes one or more non-transitory computer readable medium, such as, without limitation, random access memory (RAM), flash memory, a hard disk drive, a solid state drive, a compact disc, a digital video disc, and/or any suitable memory. Memory device 304 may include data as well as instructions that are executable by processor 302 to program processor 302 to perform the functions described herein. For example, the methods described herein may be performed by one or more processors 302 executing instructions stored within one or more memory devices 304.

Network interface 306 may include, without limitation, a network interface controller (NIC) or adapter, a radio frequency (RF) transceiver, a public switched telephone network (PSTN) interface controller, or any other communication device that enables computing device 300 to operate as described herein. In one embodiment, network interface 306 may connect to network interfaces 306 of other computing devices 300 of system 100 through a network using any suitable wireless or wired communication protocol.

Display device 308 may include, without limitation, a liquid crystal display (LCD), a vacuum fluorescent display (VFD), a cathode ray tube (CRT), a plasma display, a light-emitting diode (LED) display, a projection display, and/or any suitable visual output device capable of displaying graphical data and text to a user. For example, display device 308 may be used to display a graphical user interface associated with browser 120 to the user.

User input device 310 may include, without limitation, a keyboard, a keypad, a touch screen, a mouse, a scroll wheel, a pointing device, a video input device that registers movement of a user, and/or any other suitable device that enables the user to input data into computing device 300 and/or retrieve data from computing device 300.

Audio output device 312 may include, without limitation, one or more speakers or any other device that enables content to be audibly output from computing device 300. For example, music or other audio content associated with one or more ads may be audibly output from audio output device 312.

Audio input device 314 may include a microphone or another suitable device that enables the user to input audio commands into computing device 300. Audio input device 314 may employ speech recognition software to convert spoken commands from the user into digital data for use in operating computing device 300.

While the foregoing computing device components have been described as being included within a computing device 300, it should be recognized that at least some computing devices 300 may not include each component. For example, a server may not include audio output device 312, audio input device 314, user input device 310, and/or display device 308. In addition, a computing device 300 may include any suitable number of each individual computing device component. For example, a co ng device 300 may include a plurality of processors 302 or processor cores, a plurality of memory devices 304 (of the same or different types, sizes, etc.), and/or a plurality of display devices 308.

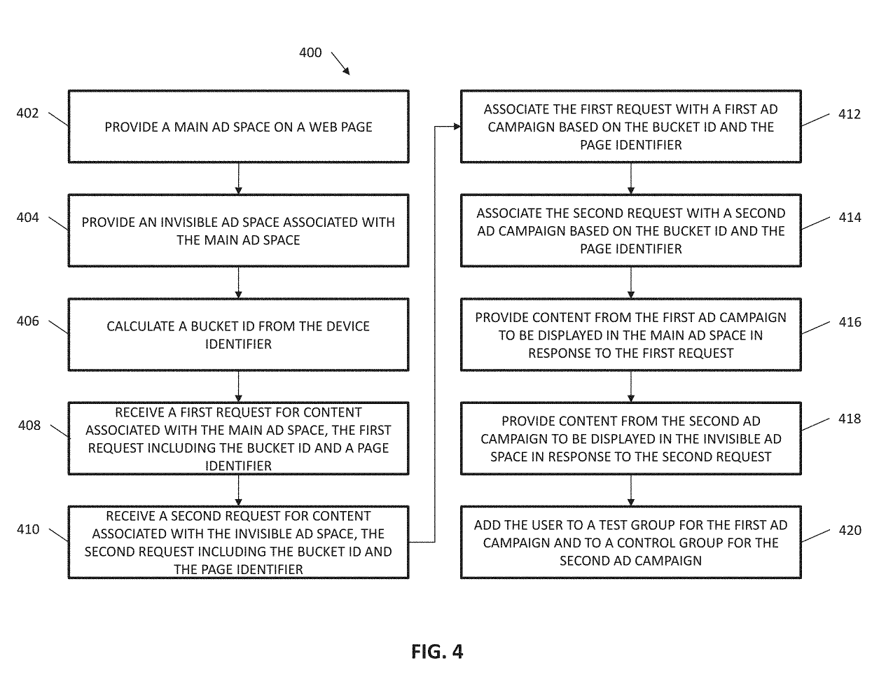

FIG. 4 is a flow diagram of an exemplary method 400 of automatically associating user computing devices with one or more ad campaigns that may be used with system 100 (shown in FIG. Method 400 may be implemented by user computing device 102, web server 104, and/or ad server 106 (shown in FIG. 1), such as by a processor 302 of user computing device 102, web server 104, and/or ad server 106 executing computer-readable instructions stored within a memory device 304 of user computing device 102, web server 104, and/or ad server 106. Alternatively, method 400 may be implemented by any suitable processor of system 100.

Method 400 includes providing 402 a main ad space on a web page, such as main content space 202 on web page 118 (shown in FIGS. 1 and 2) and providing 404 an invisible ad space associated with the main ad space on the web page, such as invisible content space 204 on web page 118. In one embodiment, for each main ad space provided on the web page, one associated invisible ad space is provided on the web page. As described above, the main ad space is sized and placed on the web page in a manner designed to be visible to the user, while the invisible ad space is sized and placed on the web page in a manner designed to be not visible to the user.

A user computing device, such as user computing device 102 (shown in FIG. 1), calculates 406 a bucket identifier (or “bucket ID”) from a device identifier of the user computing device. The device identifier may be the device identifier described above with reference to FIG. 1, or the device identifier may be any other suitable device identifier. The bucket ID may be calculated using JavaScript, for example, using the browser of the user computing device. In one embodiment, the web server or ad server first determines what percentage of users a particular campaign is designed to present the main ads to (i.e., a test or treatment group) and what percentage of users the campaign is designed to present the invisible ads to (i.e., a control group).

The web server or ad server then determines a number of groups or buckets to place the users into when the users visit each web page. For example, an ad campaign may be designed to place 80% of the users into a test group which is presented the main ad and to place 20% of the users into a control group which is presented the invisible ad. In this example, the web server may determine that 10 groups or buckets of users should be created with users being split evenly among 8 groups or buckets associated with the main ad and 2 groups or buckets associated with the invisible ad. The web server may then provide the JavaScript code with the web page elements to cause the user computing device to create a bucket ID for a particular user by executing a hash algorithm on the device identifier received from the first and second ad requests and taking the remainder of the outcome of the hash algorithm divided by the number of groups (10 in this example). In equation form, the user computing device may calculate the bucket ID to be:

bucket_ID=hash(device_ID)mod(num_groups) Eq. 1

where bucket_ID is the bucket identifier, hash is the hash function, device_ID is the device identifier, and num_groups is the number of groups determined above.

A first request for content associated with the main ad space is received 408 by the ad server from the user computing device. The first request includes the bucket ID and a page identifier. The page identifier may include a value or other identifier representative of the web page the user is browsing via the browser of the user computing device.

A second request for content associated with the invisible ad space is received 410 by the ad server from the user computing device. Similar to the first request, the second request includes the bucket ID and the page identifier.

The ad server determines which ad campaign should be associated with the user computing device based on the bucket ID and the page identifier. In one embodiment, the ad server associates 412 the first request with a first ad campaign based on the bucket ID and the page identifier and associates 414 the second request with a second ad campaign based on the bucket ID and the page identifier. For example, the ad server may associate the first request and second request with respective ad campaigns according to the example shown in Table 1, where the heading “Page_ID” corresponds to the page identifier and the heading “Bucket_ID” corresponds to the bucket identifier.

TABLE 1

| Ad Campaign | Page_ID | Bucket_ID | Ad Content |
|---|---|---|---|
| Campaign #1 | Baby | NOT (9 OR 10) | Main Ad #1 |
| | Baby | 9 OR 10 | Invisible Ad #1 |
| Campaign #2 | Beauty | NOT (1 OR 2) | Main Ad #2 |
| | Beauty | 1 OR 2 | Invisible Ad #2 |
| Campaign #3 | Baby | NOT (3 OR 4) | Main Ad #3 |
| | Baby | 3 OR 4 | Invisible Ad #3 |

In the example shown in Table 1, if the user is visiting a web page dedicated to baby products (Page_ID=Baby), then the ad server would narrow down the potentially relevant ad campaigns to campaign #1 or campaign #3. If the bucket ID for the user computing device set out in the first and second requests is 9, then the ad server associates the first request for the main ad content with campaign #3 and the second request for the invisible ad content with campaign #1. These examples are merely for illustration, and it should be recognized that any suitable number of groups and any suitable campaigns may be provided and associated with the ad requests received from the user computing device.

The ad server then provides 416 content from the first ad campaign to be displayed in the main ad space in response to the first request and provides 418 content from the second ad campaign to be displayed in the invisible ad space in response to the second request. In the example above, the first request for the main ad space was associated with campaign #3 and the second request for the invisible ad space was associated with campaign #1. Accordingly, the ad server provides 416 the main ad #3 for the main ad space of the web page to the user computing device in response to the first request. The ad server provides 418 the invisible ad #1 for the invisible ad space of the web page to the user computing device in response to the second request.

The web server and/or the ad server also adds 420 the user to a test group for the first ad campaign and to a control group for the second ad campaign to facilitate determining the effectiveness of the respective ad campaigns. The web server and/or the ad server may store a record in memory that includes the device identifier for the user computing device, the bucket ID calculated above, the main ad shown to the user, the invisible ad shown to the user, the ad campaign associated with the main ad, the ad campaign associated with the invisible ad, and the web page the user was browsing, for example. This record may then be correlated with the purchase history of the user to determine whether the main ad shown to the user influenced the user to purchase a product associated with the main ad.

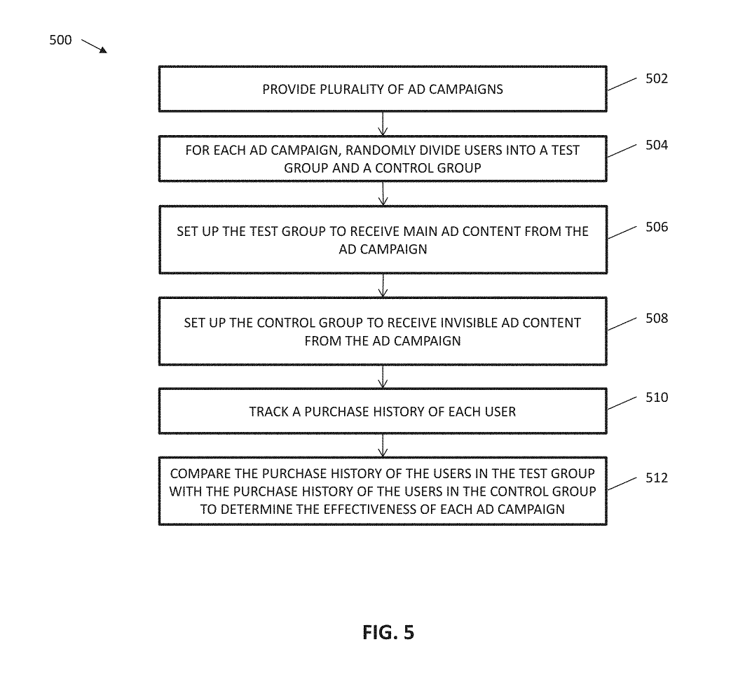

FIG. 5 is a flow diagram of an exemplary method 500 of determining an effectiveness of one or more ad campaigns that may be used with system 100 (shown in FIG. 1). Method 500 may be implemented by user computing device 102, web server 104, and/or ad server 106 (shown in FIG. 1), such as by a processor 302 of user computing device 102, web server 104, and/or ad server 106 executing computer-readable instructions stored within a memory device 304 of user computing device 102, web server 104, and/or ad server 106. Alternatively, method 500 may be implemented by any suitable processor of system 100.

In one embodiment, a plurality of ad campaigns is provided 502. Each ad campaign includes at least one main ad and at least one invisible ad. The main ad is designed to be placed in a main ad space of a web page, such as main content space 202 of web page 118, while the invisible ad is designed to be placed in an invisible ad space of the web page, such as invisible content space 204 of web page 118.

For each ad campaign, users that visit a web page with user computing devices are randomly assigned or divided 504 into a test group and a control group. The random division or assignment of the users may be accomplished, for example, using Eq. 1 described above with reference to FIG. 4. More specifically, a bucket ID may be calculated based off of the device identifier of each user computing device. Each user or user computing device is then assigned to a test group of at least one ad campaign and to a control group of at least one other ad campaign based on the bucket identifier and based on a page identifier of the web page the user is browsing.

The ad server sets up or configures 506 the test group to receive main ad content from the ad campaign and sets up or configures 508 the control group to receive invisible ad content from the ad campaign. Accordingly, the users placed into the test group will receive the main ad from the ad campaign and the users placed into the control group will receive the invisible ad from the ad campaign.

A purchase history is tracked 510 for each user that visits the web page. The purchase history includes a list of the products of the retailer that have been purchased by the user with the user computing device. In one embodiment, the purchase history also includes the products purchased by the user at physical retail stores (i.e., brick and mortar stores) of the retailer. The purchase history of the user resulting from purchases at the web page and at the retail stores may be correlated and combined using a loyalty card number of the user, one or more credit card numbers used by the user when making the purchases, an email address used by the user to receive electronic receipts, a phone number of the user, and/or any other suitable identifier that allows correlation between the user's online and in-store purchases.

The purchase history of the users in the test group is compared 512 with the purchase history of the users in the control group to determine the effectiveness of each ad campaign. For example, the web server tracks the percentage of users of the test group for an ad campaign that were exposed to a main ad of the ad campaign and that ultimately purchased a product associated with the ad campaign. The web server also tracks the percentage of users of the control group for the ad campaign that were served the invisible ad associated with the ad campaign and that ultimately purchased the product associated with the ad campaign. The web server then calculates the difference between the percentages to determine the effectiveness of the ad campaign. For example, if 5% of the users of the test group that were exposed to the main ad ultimately purchased the product, and 3.5% of the users of the control group that were exposed to the invisible ad purchased the product, the incremental effectiveness or conversion of the ad campaign may be calculated to be 1.5%.

Although specific features of various embodiments of the disclosure may be shown in some drawings and not in others, this is for convenience only. In accordance with the principles of the disclosure, any feature of a drawing or other embodiment may be referenced and/or claimed in combination with any feature of any other drawing or embodiment.

This written description uses examples to describe embodiments of the disclosure and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a memory device configured to store a plurality of web page elements that may be rendered on a browser of a user computing device to display a web page, wherein the web page includes a first ad space for displaying an ad that is configured to be visible to the user and a second ad space for displaying an ad that is configured to not be visible to the user;
a web server coupled to the memory device, the web server configured to:
receive a request from the user computing device to display the web page; and
provide the web page elements to the user computing device to enable the browser of the user computing device to display the web page; and
an ad server configured to:
receive a first ad request for the first ad space from the user computing device;
receive a second ad request for the second ad space from the user computing device, wherein the first ad request and the second ad request include an identifier associated with the user computing device;
associate the first ad request with a first ad campaign based on the identifier;
associate the second ad request with a second ad campaign based on the identifier;
provide a first ad from the first ad campaign to the user computing device in response to the first ad request to enable the first ad to be visible to the user; and
provide a second ad from the second ad campaign to the user computing device in response to the second ad request to enable the second ad to not be visible to the user.

2. The system of claim 1, wherein the web server is further configured to store a history of the user's purchases from the web page within a purchase history database.

3. The system of claim 2, wherein the web server is further configured to determine an effectiveness of the first ad campaign based at least in part on the history of the user's purchases from the web page.

4. The system of claim 3, wherein the purchase history database also includes a history of the user's purchases from at least one retail store.

5. The system of claim 4, wherein the web server is further configured to determine the effectiveness of the first ad campaign based on the purchases of the user from the web page and from the at least one retail store.

6. The system of claim 1, wherein the first ad campaign includes the first ad and a third ad that is configured to be not visible, and wherein the first ad is provided to a first plurality of users and the third ad is provided to a second plurality of users.

7. The system of claim 6, wherein the web server is further configured to determine an effectiveness of the first ad campaign by comparing purchases made by the first plurality of users to purchases made of the second plurality of users.

8. The system of claim 1, wherein the first ad request and the second ad request include a web page identifier, the first ad request being associated with the first ad campaign based on the web page identifier and the second ad request being associated with the second ad campaign based on the web page identifier.

9. The system of claim 1, wherein the second ad space is sized to be 1 pixel by 1 pixel such that when the second ad is displayed in the second ad space, the second ad is not visible to the user.

10. The system of claim 1, wherein the web page includes a plurality of first ad spaces for displaying ads that are configured to be visible to the user and a plurality of second ad spaces for displaying ads that are configured to be not visible to the user, wherein each second ad space of the plurality of second ad spaces is associated with a respective first ad space of the plurality of first ad spaces.

11. A method, comprising:
storing a plurality of web page elements within a memory device of a web server, the plurality of web page elements enabling a browser of a user computing device to render a web page, wherein the web page includes a first ad space for displaying an ad that is configured to be visible to the user and a second ad space for displaying an ad that is configured to not be visible to the user;
receiving a request from the user computing device to display the web page;
providing the web page elements to the user computing device to enable the browser of the user computing device to display the web page;
receiving a first ad request for the first ad space from the user computing device;
receiving a second ad request for the second ad space from the user computing device, wherein the first ad request and the second ad request include an identifier associated with the user computing device;
associating the first ad request with a first ad campaign based on the identifier;
associating the second ad request with a second ad campaign based on the identifier;
providing a first ad from the first ad campaign to the user computing device in response to the first ad request to enable the first ad to be visible to the user; and
providing a second ad from the second ad campaign to the user computing device in response to the second ad request to enable the second ad to not be visible to the user.

12. The method of claim 11, further comprising storing a history of the user's purchases from the web page within a purchase history database.

13. The method of claim 12, further comprising determining an effectiveness of the first ad campaign based at least in part on the history of the user's purchases from the web page.

14. The method of claim 13, wherein the purchase history database also includes a history of the user's purchases from at least one retail store.

15. The method of claim 14, further comprising determining the effectiveness of the first ad campaign based on the purchases of the user from the web page and from the at least one retail store.

16. The method of claim 11, wherein the first ad campaign includes the first ad and a third ad that is configured to be not visible, the method further comprising providing the first ad to a first plurality of users and providing the third ad to a second plurality of users.

17. The method of claim 16, further comprising determining an effectiveness of the first ad campaign by comparing purchases made by the first plurality of users to purchases made of the second plurality of users.

18. The method of claim 11, wherein the first ad request and the second ad request include a web page identifier, the method further comprising associating the first ad request with the first ad campaign using the web page identifier and the second ad request with the second ad campaign using the web page identifier.

19. The method of claim 11, further comprising providing the second ad space with a 1 pixel by 1 pixel size such that when the second ad is displayed in the second ad space, the second ad is not visible to the user.

20. The method of claim 11, further comprising providing the web page with a plurality of first ad spaces for displaying ads that are configured to be visible to the user and a plurality of second ad spaces for displaying ads that are configured to be not visible to the user, and associating each second ad space of the plurality of second ad spaces with a respective first ad space of the plurality of first ad spaces.
